(19) United States
(12) Patent Application Publication
(10) Pub. No.: US 2010/0291324 A1
(43) Pub. Date: Nov. 18, 2010

(54) COPY PROTECTED PAPER

(76) Inventors: Irene Antoinette Petra Hovens, Venlo (NL); Lawrence Fabian Batenburg, Eindhoven (NL); Johannes Wilhelmus Timmermans, Ede (NL); Cornelis Hermanus Arnoldus Rentrop, Eindhoven (NL); Jan Matthijs Jetten, Zeist (NL); Daniël Hendrik Turkenburg, Eindhoven (NL)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/740,766

(22) PCT Filed: Oct. 31, 2008
(86) PCT No.: PCT/NL2008/050683

§ 371 Date: Aug. 6, 2010

(30) Foreign Application Priority Data
Oct. 31, 2007 (EP) 07119762.8

(51) Int. Cl. B32B 7/02; B41M 5/00; B05D 3/00

(52) U.S. Cl. 428/32.19; 428/212; 427/385.5; 427/258

(57) ABSTRACT

The invention is directed to copy protected paper, to a method for producing said paper, the use of a specific layer for copy protection of paper, and a method for protecting a printable paper from being copied. Copy protected paper comprising a printable paper having, on a side to be printed or a printed side, a first transparent layer, wherein said first transparent layer has a difference in refractive index with i) said paper; or ii) an optional second transparent layer being provided on said paper on the side to be printed or the printed side, wherein said difference in refractive index is at least 0.05.

The invention is directed to copy protected paper, to a method for producing said paper, the use of a specific layer for copy protection of paper, and a method for protecting a printable paper from being copied.

Paper is used as a medium for recording all kinds of printed information. Normally such information can be copied, for instance by means of a photocopier. However, in particular when the information contained on the paper is valuable (such as in the case of banknotes, cheques, licences, certificates, paper with copyright information, or other security paper) it is not desirable that the original can easily be copied.

In the prior art several attempts have been made to protect a paper original from being copied. Some of these attempts are directed at adjusting photocopiers, others are directed at using special inks or toners, still others are directed at the use of specific printing technologies. It would, however, be desirable to have a paper that is protected against making copies. Ideally, the copy of such a paper would be unreadable or unrecognisable. However, it would already be advantageous to be able to immediately distinguish the copy from the original.

JP-A-2004 188 950 describes a paper having a black camouflage pattern printed thereon. A layer of fluorescent ink is provided on top of the black camouflage pattern. Information printed on this paper can be read by irradiating the paper with black light and the fluorescent layer emits coloured light. A copy of the original turns out black because of the black camouflage pattern. Major disadvantages of this paper are that the original paper has a black colour and that the information on the original can only be read by irradiating the paper with black light.

JP-A-4 201 562 describes a paper on which is provided a resin layer containing transparent fine particles having reflective ability and reflective pigment. Incident light transmits through the transparent fine particles and is reflected by the reflective pigment, which is emitted from the transparent fine particles. Due to the reflective pigment, the resin layer is visible. Furthermore, in order to have the desired effect, a combination of transparent fine particles with the reflective pigment is required.

EP-A-0 171 252 describes a transparent sheet, which sheet contains an authenticating retroreflective image. The sheet comprises a monolayer of transparent microlenses, preferably glass microspheres having average diameters in the range of 10 to 300 μm. The sheet is applied as an overlay on top of an already printed original document.

Object of the invention is to at least partially overcome the disadvantages of the prior art.

Another object of the invention is to protect a paper from being copied using a layer that is not visible.

A further object of the invention is to provide a paper that is protected from copying in that the copy can be immediately distinguished from the original.

Another object of the invention is to provide an accessible and cheap method for protecting printable paper from being copied.

The inventors found that one or more of these objects can be met by providing a paper with specific refractive index properties.

Accordingly, in a first aspect the invention is directed to a copy protected paper comprising a printable paper having, on a side to be printed or a printed side, a first transparent layer, wherein said first transparent layer has a difference in refractive index with
i) said paper; or
ii) an optional second transparent layer being provided on said paper on the side to be printed or the printed side,
   wherein said difference in refractive index is at least 0.05.

The term “copy protected paper” as used herein refers to a paper that can contain printed information and of which the copied information is at least significantly different than the original information. Thus, when the original information contained on the copy protected paper is copied, the information on the copy is at least significantly different than the original information. The copied information can for instance be in the form of a photocopy, but also a scan of the original, for instance by a digital scanner, is considered a copy in the context of this invention.

The copy protected paper of the invention thus comprises a printable paper which is overlaid with at least one transparent layer. If desirable, the transparent layer can be printed on. The paper can be printed on before application of the layer. Of course, also the combination of these possibilities (i.e. a paper which is printed on before application of the transparent layer and which is to be printed thereafter) is an option.

The transparent layer of the copy protected paper of the invention can also be a multilayer, comprising more than one layer, such as 2-20 layers. It is preferred that such a multilayer design has at least one time a refractive index difference of 0.05 between different layers, preferably at least 2 times, more preferably at least 3 times, and even more preferably at least 5 times. In a more preferred embodiment the multilayer design has at least one time a refractive index difference of 0.1 between different layers. The one or more transparent layers can suitably be prepared by wet coating techniques and/or by gas phase deposition.

The difference in refractive index between the transparent layer and the paper or the optional second transparent layer causes the paper to be copy protected. Information that is optionally printed on the paper under the transparent layer and/or that is printed on top of the transparent layer, is visible under low angles, typically angles of less than 90°, preferably less than 70°, more preferably 70°-50°. However, under substantially right angles, typically angles of 30°-90°, preferably angles of 70°-90°, more preferably angles of 90°, the information becomes invisible because of total reflection.

In the most extreme form the transparent layer under substantially right angles functions as a mirror and totally reflects the light of a copying device. As almost all copying devices shine light onto the original under right angles or substantially right angles, the paper is protected from being copied by almost all copying devices.

The difference in refractive index is at least 0.05, preferably at least 0.1. The refractive index can reliably be measured by refractometry. The refractive index is usually measured or expressed in index at 550 nm. In a more preferred embodiment the difference in refractive index is at least 0.2, preferably at least 0.5, more preferably 0.5-1.0. The larger the difference in refractive index, the wider the angle under which incident light is totally reflected. At very big differences in refractive index, such as differences of more than 1.0, a large extent of light is reflected so that information on the original becomes hard to distinguish with bare eye. For instance, if the information is in the form of a text, the original may be hard or impossible to read.

In principle, the refractive index of the transparent layer can be either lower or higher than the refractive index of the paper or optional second transparent layer. In practice, it has been found convenient to prepare a transparent layer with a refractive index that is higher than the refractive index of the paper or optional second transparent layer.

The term “paper” as used in this application is meant to refer to all types of cellulose-based products in sheet or web form. Examples of suitable papers include bank paper, drawing paper, printer paper (such as inkjet paper), copier paper and photographic paper. Cellulose-based paper normally has a refractive index of about 1.56 (Dissertation of Tapio Fabritius, Acta Univ. Oul., C 269, April 2007, Finland, ISBN 978-951-42-8404-5).

In accordance with the invention it is also possible that the paper is coated. Coating may exist of an inorganic coating such as china clay, TiO₂ and/or latex. Also resin coated paper can be used.

The one or more transparent layers can suitably independently from each other comprise an organic polymer as a binder. In a preferred embodiment the organic polymer is selected from the group consisting of starch, cellulose, polyvinylalcohol and derivatives thereof. Particularly, preferred organic polymers are for instance copolymers of polyvinyl alcohol and polyvinyl acetate optionally with itaconic acid, carboxymethylcellulose, and amylase free potato starch (for instance the amylopectin potato starch Eliane™, commercially obtainable from AVEBE).

The one or more transparent layers of the paper according to the invention can independently from each other comprise inorganic particles. If particles are present, these particles should have an average particle size, which is smaller than the wavelength of light in the visible in order to prevent scattering of light, which would make the layer non-transparent. Thus, the particles can have an average particle size of 0.5-200 nm, preferably 0.6-100 nm, more preferably 0.7-50 nm, as determined by transmission electron microscopy. It is preferred that the particles are present as non-agglomerated, or at least hardly agglomerated, individual particles. Thus, in a preferred embodiment the above-mentioned average particle sizes refer to the average particle sizes of individual particles. In principle, the particles can have any shape. However, it is preferred that the particles are non-spherical.

The inorganic particles can suitably have a refractive index of at least 0.4, preferably at least 1.0, more preferably 1.0-4.0, and most preferably 2.0-4.0 as determined by refractometry.

Inorganic particles can for instance be selected from the group consisting of TiO₂ (refractive index of the particles about 2.2), SnO₂, Si (refractive index of the particles about 4.0), Ag (refractive index of the particles about 1.35), Au (refractive index of the particles about 0.47), C (diamond) (refractive index of the particles about 2.4), ZnO (refractive index of the particles about 2.0), ZrO₂ (refractive index of the particles about 2.2), CeO₂ (refractive index of the particles about 2.3), Hf₂O₃ (refractive index of the particles about 1.9), mica particles (refractive index of the particles about 1.50 to 1.70) and (organically modified) clays (refractive index of the particles about 1.50). Commercial mica particles may be coated with rutile (TiO₂ structure with refractive index of about 2.63), tin oxide (refractive index of about 2), and/or various iron oxides.

It was found that if the transparent layer closest to the paper comprises mica, preferably mica coated with rutile titanium dioxide, tin oxide, and/or iron oxide, the copy protection is enhanced. Without wishing to be bound by theory, it is believed that this is due to additional reflection of the incoming light by the underlying mica layer.

In a preferred embodiment, the first transparent layer comprises inorganic particles having a refractive index difference of at least 0.2 compared to the paper or the optional second transparent layer, preferably a difference of at least 1.0, more preferably at least 1.5 as determined by refractometry. It was found that inorganic particles with a refractive index that strongly differs from the refractive index of the paper or the optional second transparent layer significantly contribute to the copy protection of the paper.

The inorganic particles can be dispersed in the organic polymer binder. Preferably, the particles are dispersed homogeneously and the formation of aggregates is prevented. Aggregate formation could lead to an aggregate particle size which is larger than the wavelength of light, thereby causing light scattering and in turn leading to a non-transparent layer. In order to increase the compatibility of the particles with the organic polymer it is possible to modify the surface of the inorganic particles. Typically, the surface of the inorganic particles is modified with organic compounds comprising ammonium, phosphonium, carboxylic, siloxane, and/or hydroxylic groups.

Another possibility to make the inorganic particles more compatible with the organic polymer binder is to add one or more surfactants to the transparent layer. Suitable surfactants include block-copolymers. Suitable blocks for use in the block-copolymers for instance include polyethylene oxide, maleic acid anhydride, carbonic acid, alcohol, and polyethylene glycol, polypropylene, polyethylene, polystyrene, polymethylmethacrylate, polyamide, and polyethylene oxide. The block-copolymers may be provided with a functional terminus, such as a carbonic acid group, a hydroxyl group, or an epoxy group. It is also possible to combine the addition of surfactants with a surface modification of the inorganic particles.

The amount of the particles in the one or more transparent layers can be chosen in a wide range. It is preferred that the one or more transparent layers independently from each other comprise 1-50 wt. %, preferably 20-40 wt. %, more preferably 30-40 wt. % of the inorganic particles. The ratio between the inorganic particles and the organic polymer in the transparent layer is preferably at least 5:95, more preferably at least 50:50. When the ratio between inorganic particles and organic polymer binder in the transparent layer is more than 50:50, this can cause problems in the preparation of the layer. Accordingly, the ratio between the inorganic particles and the polymer binder in the transparent layer is preferably in the range of 2:98-40:60, more preferably 10:90-20:80. A high amount of inorganic particles compared to the amount of organic polymer may cause problems in viscosity of a coating solution that can be used to prepare the transparent layer. In addition, such a high relative amount of inorganic particles can lead to less transparent layers. If the amount of inorganic particles is very low it becomes more difficult to realise a sufficiently high difference in refractive index with the paper.

In a special embodiment of the invention, the inorganic particles are quantum dots (semiconductor nanoparticles), which are optionally fluorescent.

The one or more transparent layer may further independently from each other comprise one or more dyes. The dyes can be inorganic, organic, or a mixture of inorganic and organic dyes can be used. Suitable organic dyes are for instance acridine dyes, anthraquinone dyes, diarylmethane dyes, triarylmethane dyes, azo dyes, phtalocyanine dyes, diazonium dyes, quinone dyes, azin dyes, indamine dyes, indophenol dyes, oxazin dyes, oxazone dyes, thiazin dyes, thiazole dyes, xanthene dyes, fluorene dyes, rhodamine dyes, and fluorone dyes. The inventors found that the provision of a dye in the first transparent layer can cause an additional show-through effect during copying of the original, i.e. when information is provided on both sides of the original, the single-sided copy contains the information of both sides of the original.

It was found that the presence of one or more dyes in the first transparent layer can lead to a show-through effect. Without wishing to be bound by theory, it is believed that this show-through effect relates to a spectral overlap of the absorption of the dye in the transparent layer with the emission spectrum of the lamp of the photocopying machine or scanner. It is believed that the show-through effect increases when this spectral overlap is increased.

Therefore it in a preferred embodiment, the first transparent layer comprises a dye which has an absorption spectrum that overlaps with the emission spectrum of the lamp of the photocopier.

If one or more dyes are included, it is preferred that the dyes are strongly absorbing. The dye can have for example a molar extinction coefficient at its absorption maximum of at least 10 000 Lmol⁻¹ cm⁻¹, preferably at least 20 000 Lmol⁻¹ cm⁻¹, more preferably at least 50 000 Lmol⁻¹ cm⁻¹. In practice there are only few dyes with a molar extinction coefficient of more than 200 000 Lmol⁻¹ cm⁻¹.

In a special embodiment, the one or more transparent layers independently from each other comprise one or more emitting dyes, preferably fluorescent dyes. Suitable fluorescent dyes include fluoresceins, rhodamines, coumarins, and the like. Also phosphorescent dyes can be used. Irradiation by a lamp of a photocopying machine can bring the emitting dye in an excited state after which the dye can emit light, either by fluorescence or by phosphorescence. This emitted light can interfere with the photocopying process. Fluorescent dyes are preferred over phosphorescent dyes, because fluorescence is a faster relaxation process than phosphorescence.

When the one or more transparent layers comprise emitting dyes, it is preferred that the copy protected paper is provided with means to concentrate the emitted light. Such means can for instance be grooves or pits in one or more transparent layers. Such grooves or pits in should have a dimension larger than the wavelength of the emitted light. It was found that such grooves or pits can efficiently concentrate the emitted light, thereby increasing the interference with the photocopying process. The grooves or pits, which are hardly visible in the original because of their small size (typically smaller than 100 μm, preferably smaller than 50 μm), appear in the copy as bright areas as a result of the interfering emitted light.

For very thin layers the observed total reflection effect becomes small. In such cases a copy of the information printed on the copy protected paper may not be not unrecognisable, but still distinguishable from the original. Preferably, the one or more single transparent layers on the paper preferably have a layer thickness of at most 1 000 nm, preferably at most 500 nm, more preferably at most 200 nm. The layer thickness can be reliably measured by a profilometer. It is in general difficult to fabricate single layers with a layer thickness of more than 5 μm. In a preferred embodiment, the one or more single transparent layers have a layer thickness of 100-500 nm for the wet chemically applied layers. Single layers applied by gas phase deposition are to be applied at a thickness of 50 to 150 nm. For better performance the layers can be stacked. Suitably a stack can comprise at least 2 layers, preferably at least 5 layers, more preferably at least 15 layers.

In a further aspect the invention is directed to a method of preparing a copy protected paper as described above, comprising
providing a printable paper, wherein said paper is optionally printed on thereby providing said paper with a printed side;
optionally providing said paper with a transparent layer on the side to be printed or on the printed side;
providing a coating composition, optionally comprising an organic polymer, which coating composition, when dried, has a refractive index that differs at least 0.05, preferably at least 0.1, from the refractive index of said printable paper or from the refractive index of said transparent layer;
applying said coating composition onto the printed side or to a side of said paper to be printed on; and
drying said coating composition.

The optional transparent layer can be applied before or after applying the coating composition onto the paper.

The coating solution can simply be prepared by mixing the components together in a suitable mixing process. Optionally, solvents can be added. Suitable solvent for instance include water, alcohols (such as ethanol, pronanol, isopropanol, butanol, and the like), ketones (such as aceton, methylethylketone, and the like). Subsequently, the coating composition is applied to the optionally printed paper. This can be performed by any coating method known in the art, such as air knife coating, immersion (dip) coating, gap coating, curtain coating, rotary screen coating, reverse roll coating, gravure coating, metering rod (meyer bar) coating, slot die (extrusion) coating, or hot melt coating. At least the side to be printed should be coated in accordance with the method of the invention. It is possible to coat more than one side of the paper.

As mentioned above the paper can be a coated paper. Optionally, the coated paper can be printed on, and subsequently the optionally printed paper can be overlaid with the transparent layer.

In yet a further aspect the invention is directed to a method of preparing a copy protected paper as describe above, comprising
providing a printable paper, wherein said paper is optionally printed on thereby providing said paper with a printed side;
optionally providing said paper with a transparent layer on the side to be printed or on the printed side;
applying a transparent layer onto the printed side or to a side of said paper to be printed on by a gas phase deposition process, wherein said layer, after being applied by gas phase deposition, has a refractive index that differs at least 0.05, preferably at least 0.1, from the refractive index of said printable paper or from the refractive index of said optional transparent layer.

The optional transparent layer can be applied before or after application of the transparent layer that is applied by gas phase deposition. In a preferred embodiment, multiple transparent layers are deposited by gas phase deposition. It is preferred that such a multilayer design has at least one time a refractive index difference of 0.05 between different layers, preferably at least 2 times, more preferably at least 3 times, and even more preferably at least 5 times. In a more preferred embodiment the multilayer design has at least one time a refractive index difference of 0.1 between different layers.

The gas phase deposition process can suitably be chosen from chemical vapour deposition, plasma enhanced chemical vapour deposition, atmospheric pressure chemical vapour deposition, sputter deposition, electron beam physical vapour deposition, or the like. Furthermore, various materials may be used for the gas phase deposited layers. The layers can be deposited from metal organic precursors, such as tetraethoxy ortho silicate (TEOS), tetraisopropoxytitanate, tin chloride, metals like Al, Au, Cr, Cu, Ge, Hf, In, Sn, Ir, Mo, Nb, Ni, Pt, Ta, Ti, W, Zr or Zn, or their oxides. Also combinations of these materials are possible.

The porosity of the layer can assist in creating a high refractive index coating. Layers with lower porosity in general have a higher refractive index difference with the paper. Therefore, it is preferred that the porosity of the first transparent layer is less than 10% as measured by ellipsometry, preferably less than 1%, more preferably less than 0.1%.

In a further aspect the invention is directed to a method of protecting a printed paper or a paper to be printed from being copied comprising applying on the paper, on the printed side or on the side to be printed, at least a first transparent layer as defined above.

In yet a further aspect the invention is directed to the use of the first transparent layer as defined herein above as a copy protection for information printed or to be printed on a paper.

The copy protected paper of the invention can e.g. be used for copy sensitive information, such as the information on paper money, banknotes, cheques, licences, certificates, vouchers, tickets, papers with copyright information, or any other security paper.

### EXAMPLES

### Preparation of Coating Solutions

TEOS (Coating Solution 1 (25% w/w))
10.86 g TEOS (tetraethoxysilane) and 22.84 g IPA (isopropylalcohol) was mixed at 0° C. (ice bath) for 15 minutes while adding dropwise 4.4 g 1 M HNO₃ and 1.7 g of demineralised water. Next this solution was refluxed at 80° C. for 2 hours. This solution is mentioned as the stock solution 1 (25% w/w). The refractive index of this coating is 1.45.

### PVA Mica Sparkle Solution

A 7% (w/w) solution of polyvinyl alcohol (Mowiol18-88, Mw 130 k Da Fluka, refractive index of 1.50) in DEMI water is prepared. Mica (Sparkle 139P, Exterior Mearlin) is added up to a concentration of 10% (w/w). This type of mica based particles is coated with TiO₂ and tin oxide.

### PVA Mica Magna Pearl Solution

A 7% (w/w) solution of polyvinyl alcohol (Mowiol18-88, Mw 130 k Da Fluka, refractive index of 1.50) in DEMI water is prepared. Mica (Magna Pearl 5000) is added up to a concentration of 10% (w/w). Magna Pearl 4000 can also be used instead of Magna Pearl 5000.

### Dipping Procedure

The papers were dipped in the coating solutions attached to a glass plate to prevent wrinkling. The papers were totally submerged for 25 seconds before the dipping process (upward motion) was started.

### Example 1

### TEOS (25% w/w)

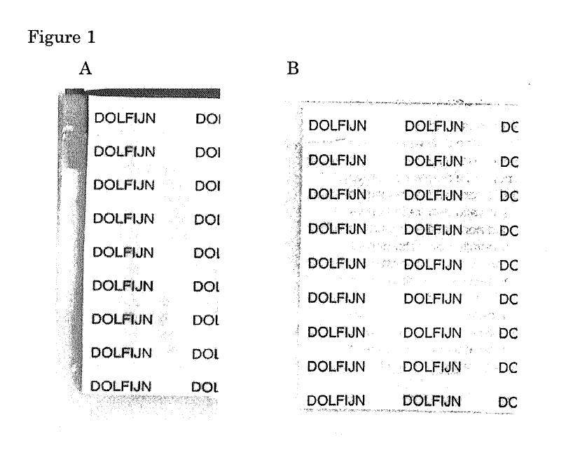

Regular copying paper (79 g/m²), having a refractive index of 1.56, was coated with the coating solution 1. The coating was dipped in the stock solution 1 with an upward velocity of 1 mm/s leaving behind 15.4 g/m² of coating. The difference in refractive index between the copying paper and the dried coating was 0.11. FIG. 1 shows the results copied on a Xerox standard copier (black and white). FIG. 1A is a digital photo of the original coated paper, FIG. 1B is a result of a copied coated paper at high sensitivity.

### Standard CVD Coating Procedure

Alternating layers of hafnium dioxide and silicondioxide were applied at specific layer thicknesses. The standard CVD layer contains 11 layers as specified below:

1, hafnium dioxide: 71.28 nm refractive index 1.95

2, silicon dioxide: 94.50 nm refractive index 1.46

3, hafnium dioxide: 71.28 nm refractive index 1.95

4, silicon dioxide: 94.50 nm refractive index 1.46

5, hafnium dioxide: 71.28 nm refractive index 1.95

6, silicon dioxide: 94.50 nm refractive index 1.46

7, hafnium dioxide: 53.50 nm refractive index 1.95

8, silicon dioxide: 94.50 nm refractive index 1.46

9, hafnium dioxide: 53.50 nm refractive index 1.95

10, silicon dioxide: 94.50 nm refractive index 1.46

11, hafnium dioxide: 53.50 nm refractive index 1.95

Hence, the CVD coating resulted in a multilayer with a difference in refractive index of 0.49 between each layer.

### Example 2

### Coating Composition 1

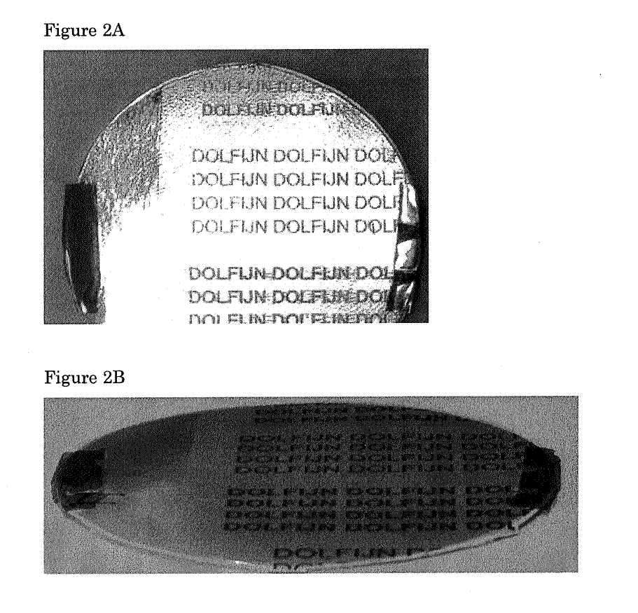

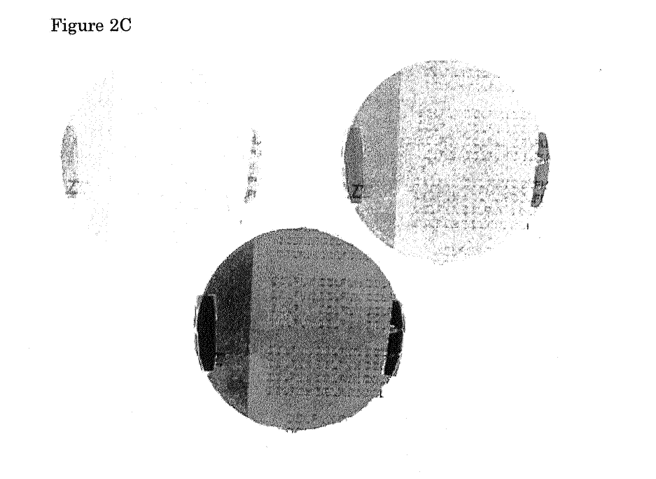

First regular photopaper (233.5 g/m²) was printed with text. After that a standard PVA mica magna pearl layer was applied using a doctor blade of 60 μM which was left to dry after which a standard CVD layer as described above was applied. On these layers additional text can be written with a pencil. FIG. 2A shows a photograph of a layer of composition 1 on paper viewed under 90 degrees. FIG. 2B is a photograph of the same layer viewed under a small angle. FIG. 2C shows copies of the layer as depicted in A and B at varying intensity settings of a copy machine.

### Example 3

### Coating Composition 2

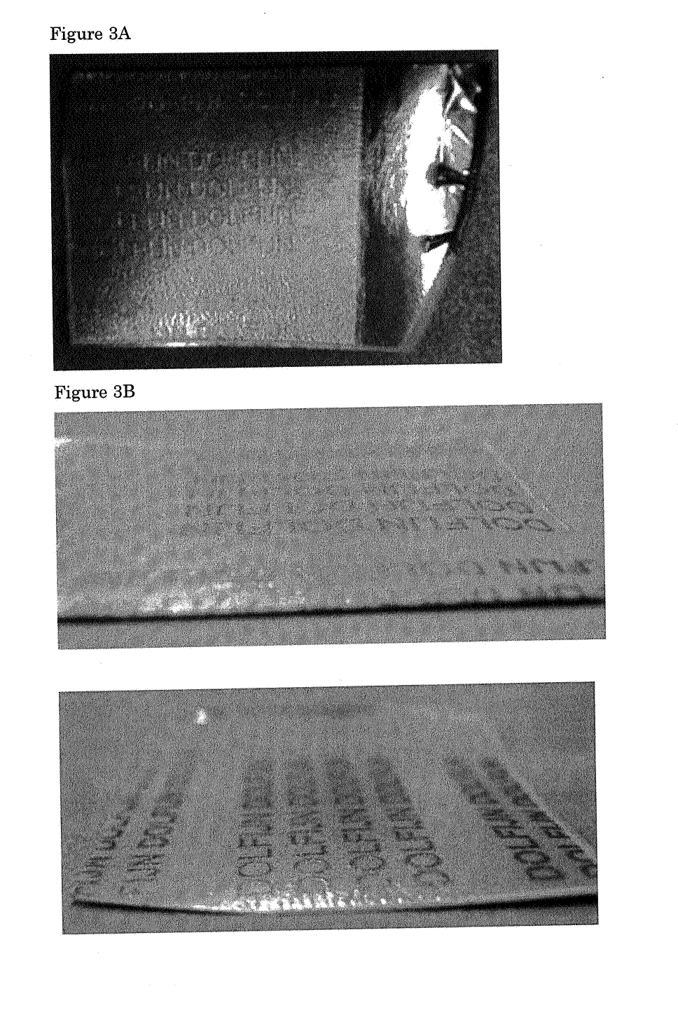

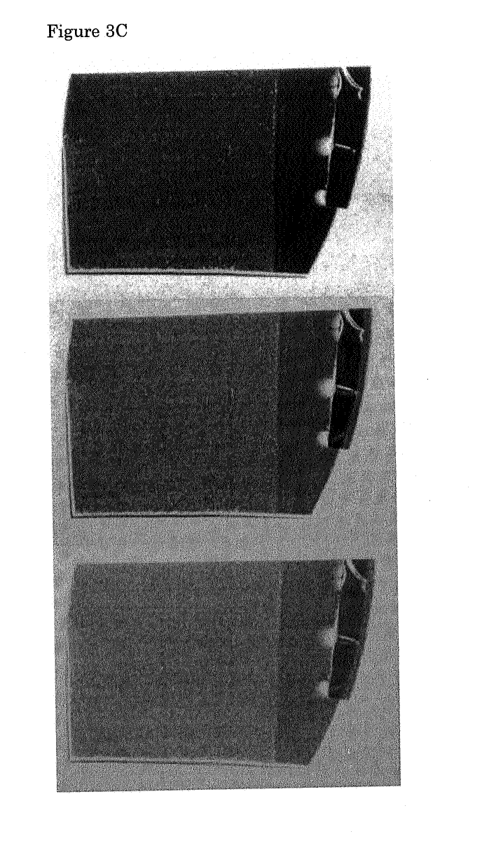

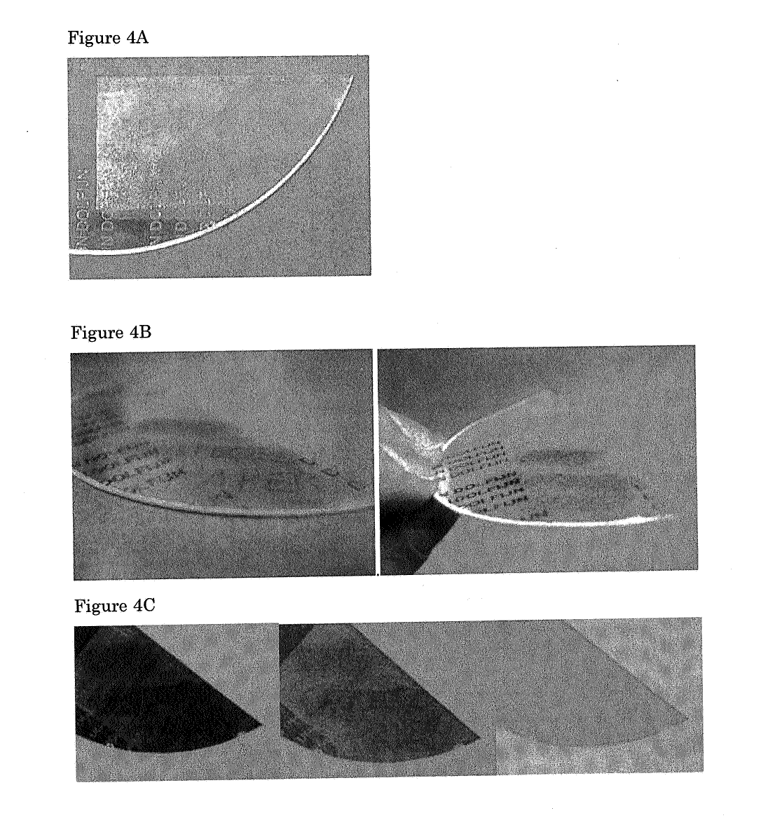

First regular photopaper (233.5 g/m²) was printed with text. After that a standard PVA mica sparkle layer was applied using a doctor blade of 60 μm which was left to dry after which a standard CVD layer as described above was applied. FIG. 3A shows a photograph of a layer of composition 2 on paper viewed under 90 degrees. FIG. 3B is a photograph of the same layer viewed under a small angle. FIG. 3C shows copies of the layer as depicted in A and B at varying intensity settings of a copy machine. On these layers additional text can bewas written with a pencil (see FIG. 4; 4A: photograph of a layer of composition 2 on paper viewed under 90 degrees; 54: photograph of the same layer viewed under a small angle; 54: copies of the layer as depicted in A and B at varying intensity settings of a copy machine).

1. Copy protected paper comprising a printable paper having, on a side to be printed or a printed side, a first transparent layer, wherein said first transparent layer has a difference in refractive index with
i) said paper; or
ii) an optional second transparent layer being provided on said paper on the side to be printed or the printed side,
wherein said difference in refractive index is at least 0.05.

2. Copy protected paper according to claim 1, wherein the first transparent layer comprises an organic polymer.

3. Copy protected paper according to claim 2, wherein the organic polymer is selected from the group consisting of starch, cellulose, polyvinylalcohol, and derivatives thereof.

4. Copy protected paper according to claim 1, wherein the first transparent layer further comprises inorganic particles having an average particle size of 0.5-200 nm, preferably 0.6-100 nm, more preferably 0.7-50 nm.

5. Copy protected paper according to claim 4, wherein said particles are non-spherical.

6. Copy protected paper according to claim 5, wherein said non-spherical particles are in the form of platelets having a width to height aspect ratio of 10 or more, wherein the orientation of the particles is such that the average angle between the plane of the platelets and the plane of the paper is less than 60°, preferably less than 45°, more preferably less than 20°.

7. Copy protected paper according to claim 1, wherein said difference in refractive index is at least 0.1, preferably at least 0.2, more preferably at least 0.5, and even more preferably 0.5-1.5.

8. Copy protected paper according to claim 4, wherein the inorganic particles are selected from the group consisting of TiO₂, SnO₂, Si, Ag, Au, C (diamond), ZnO, ZrO₂, CeO₂, Hf₂O₃, optionally coated mica, and optionally organically modified clay.

9. Copy protected paper according to claim 4, wherein the first transparent layer comprises 1-50 wt. %, preferably 20-40 wt. %, more preferably 30-40 wt. % of inorganic particles.

10. Copy protected paper according to claim 1, wherein the total thickness of the sum of transparent layers is at most 1 000 nm, preferably at most 500 nm, and more preferably at most 200 nm.

11. Copy protected paper according to claim 1, comprising at least 2 transparent layers, preferably 2-20 transparent layers.

12. Copy protected paper according to claim 11, wherein the transparent layer closest to the paper comprises mica, preferably mica coated with rutile titanium dioxide, tin oxide, and/or iron oxide.

13. Copy protected paper according to claim 4, wherein the inorganic particles have a refractive index of at least 0.4, preferably at least 1.0, more preferably 1.0-4.0, and most preferably 2.0-4.0 as determined by a refractometer.

14. Copy protected paper according to claim 4, wherein the surface of the inorganic particles is modified with one or more organic compounds.

15. Copy protected paper according to claim 14, wherein said one or more organic compounds comprise ammonium, phosphonium, carboxylic, siloxane, and/or hydroxylic groups.

16. Copy protected paper according to claim 1, wherein said first transparent layer comprises one or more dyes.

17. Copy protected paper according to claim 16, wherein said dye is an organic dye selected from the group consisting of acridine dyes, anthraquinone dyes, diarylmethane dyes, triarylmethane dyes, azo dyes, phtalocyanine dyes, diazonium dyes, quinone dyes, azin dyes, indamine dyes, indophenol dyes, oxazin dyes, oxazone dyes, thiazin dyes, thiazole dyes, xanthene dyes, fluorene dyes, rhodamine dyes, and fluorone dyes.

18. Copy protected paper according to claim 16, wherein said dye is an emitting dye.

19. Copy protected paper according to claim 1, wherein the paper is chosen from the group consisting of bank paper, drawing paper, printer paper, inkjet paper, copier paper and photographic paper.

20. Method of preparing a copy protected paper according to claim 1, comprising
providing a printable paper, wherein said paper is optionally printed on thereby providing said paper with a printed side;
optionally providing said paper with a transparent layer on the side to be printed or on the printed side;
providing a coating composition, optionally comprising an organic polymer, which coating composition, when dried, has a refractive index that differs at least 0.05, preferably at least 0.1, from the refractive index of said printable paper or from the refractive index of said transparent layer;
applying said coating composition onto the printed side or to a side of said paper to be printed on; and
drying said coating composition.

21. Method of preparing a copy protected paper according to claim 1, comprising
providing a printable paper, wherein said paper is optionally printed on thereby providing said paper with a printed side;
optionally providing said paper with a transparent layer on the side to be printed or on the printed side;
applying a transparent layer onto the printed side or to a side of said paper to be printed on by a gas phase deposition process, wherein said layer, after being applied by gas phase deposition, has a refractive index that differs at least 0.05, preferably at least 0.1, from the refractive index of said printable paper or from the refractive index of said optional transparent layer.

22. Method of protecting a printed paper or a paper to be printed from being copied comprising applying on the paper, on the printed side or on the side to be printed, a first transparent layer as defined in claim 1.

23. Use of a transparent layer as defined in claim 1, as a copy protection for information printed or to be printed on a paper.

24. Copy protected paper according to claim 2, wherein;
the first transparent layer further comprises inorganic particles having an average particle size of 0.5-200 nm, preferably 0.6-100 nm, more preferably 0.7-50 nm;
said particles are non-spherical;
said non-spherical particles are in the form of platelets having a width to height aspect ratio of 10 or more, wherein the orientation of the particles is such that the average angle between the plane of the platelets and the plane of the paper is less than 60°, preferably less than 45°, more preferably less than 20°;
said difference in refractive index is at least 0.1, preferably at least 0.2, more preferably at least 0.5, and even more preferably 0.5-1.5;
the inorganic particles are selected from the group consisting of TiO₂, SnO₂, Si, Ag, Au, C (diamond), ZnO, ZrO₂, CeO₂, Hf₂O₃, optionally coated mica, and optionally organically modified clay;
the first transparent layer comprises 1-50 wt. %, preferably 20-40 wt. %, more preferably 30-40 wt. % of inorganic particles;
the total thickness of the sum of transparent layers is at most 1 000 nm, preferably at most 500 nm, and more preferably at most 200 nm;
at least 2 transparent layers, preferably 2-20 transparent layers are provided;
the transparent layer closest to the paper comprises mica, preferably mica coated with rutile titanium dioxide, tin oxide, and/or iron oxide;
the inorganic particles have a refractive index of at least 0.4, preferably at least 1.0, more preferably 1.0-4.0, and most preferably 2.0-4.0 as determined by a refractometer;
the surface of the inorganic particles is modified with one or more organic compounds;
said one or more organic compounds comprise ammonium, phosphonium, carboxylic, siloxane, and/or hydroxylic groups;
said first transparent layer comprises one or more dyes;
said dye is an organic dye selected from the group consisting of acridine dyes, anthraquinone dyes, diarylmethane dyes, triarylmethane dyes, azo dyes, phtalocyanine dyes, diazonium dyes, quinone dyes, azin dyes, indamine dyes, indophenol dyes, oxazin dyes, oxazone dyes, thiazin dyes, thiazole dyes, xanthene dyes, fluorene dyes, rhodamine dyes, and fluorone dyes;
said dye is an emitting dye; and
the paper is chosen from the group consisting of bank paper, drawing paper, printer paper, inkjet paper, copier paper and photographic paper.

25. Method of preparing a copy protected paper according to claim 24, comprising
providing a printable paper, wherein said paper is optionally printed on thereby providing said paper with a printed side;
optionally providing said paper with a transparent layer on the side to be printed or on the printed side;
providing a coating composition, optionally comprising an organic polymer, which coating composition, when dried, has a refractive index that differs at least 0.05, preferably at least 0.1, from the refractive index of said printable paper or from the refractive index of said transparent layer;
applying said coating composition onto the printed side or to a side of said paper to be printed on; and
drying said coating composition.

26. Method of preparing a copy protected paper according to claim 24, comprising
providing a printable paper, wherein said paper is optionally printed on thereby providing said paper with a printed side;
optionally providing said paper with a transparent layer on the side to be printed or on the printed side;
applying a transparent layer onto the printed side or to a side of said paper to be printed on by a gas phase deposition process, wherein said layer, after being applied by gas phase deposition, has a refractive index that differs at least 0.05, preferably at least 0.1, from the refractive index of said printable paper or from the refractive index of said optional transparent layer.

27. Method of protecting a printed paper or a paper to be printed from being copied comprising applying on the paper, on the printed side or on the side to be printed, a first transparent layer as defined in claim 24.

28. A method wherein use of a transparent layer, as defined in claim 24, is provided as a copy protection for information printed or to be printed on a paper.
